(19) United States
(12) Patent Application Publication
(10) Pub. No.: US 2002/0041622 A1
(43) Pub. Date: Apr. 11, 2002

(54) Spread spectrum frequency hopping communications system

(76) Inventors: David Steed, American Fork, UT (US); Hugh Nielsen, Provo, UT (US)

Correspondence Address: Michael F. Krieger, Esq., KIRTON & McCONKIE, 1800 Eagle Gate Tower, 60 East South Temple, Salt Lake City, UT, 84111, US

(21) Appl. No.: 09/760,138

(22) Filed: Jan. 13, 2001

Related U.S. Application Data
(60) Provisional application No. 60/236,844, filed on Sep. 29, 2000.

(51) Int. Cl. H04K 1/00

(52) U.S. Cl. 375/132

(57) ABSTRACT

A frequency-hopping spread spectrum radio communications system that includes a compact radio transceiver having a sensitivity of between −110 and −107 dBm. The transceiver broadcasts digital signals by encoding them using 180-degree phase-shifted differential encoding and by attaching a header identifying the frequency channel of the signal. A network ID is also included in the header to identify the network that the radio belongs to. The network ID allows the receiver to detect broadcasted signals within its own network, and the channel identifier enables the receiver to know which frequency to switch to in order to track the hopped signal. The receiver knows to hop to the next channel upon detecting noise on the line.

### RELATED APPLICATION

This application claims priority to the U.S. Provisional Application Serial No. 60/236,844, filed Sep. 29, 2000, titled “FREQUENCY HOPPING DATA RADIO.”

### BACKGROUND OF THE INVENTION

1. Field of the Invention

The present invention relates generally to radio frequency digital transmission systems, and, more particularly, to spread spectrum frequency hopping data transmission systems.

2. Background Art

Wireless or radio frequency transmission is becoming increasingly more important in today's technology. Dispensing with the need for cables and complicated wiring, wireless technology enables networks to be connected quickly and easily. Several network-based applications may find wireless technology particularly advantageous, including supervisory control and data acquisition (SCADA), remote meter reading, home automation, instrument monitoring, point-of-sale (POS) systems, wireless local area networks (WLANs), and many other applications.

One type of means of radio transmission involves frequency hopping spread spectrum technology. The latter technology involves distributing a signal over various frequency channels for transmission and then collecting the signal onto its original frequency at the receiver. A pseudo noise (PN) code generator causes the original signal to “hop” between different frequencies at several times per second, making the original signal noiselike and thus hard to detect. This broadband distribution also makes the signal transmission less likely to interfere with or to be interfered with by other signals. For example, because many technologies use the 900 MHz ISM band (e.g., cell phones, pages, and cordless phones), existing 900 MHz radios are susceptible to interference and may not operate at all when close to pager or cell phone towers. Spread spectrum frequency hopping helps minimize this interference.

Frequency hopping systems, however, have their disadvantages as well. For example, the signal receiver must be able to synchronize with or track the frequency “hops” so that the receiver can properly capture and demodulate the signal. In typical frequency hopping systems, both the transmitter and the receiver have a clocking/timer mechanism to achieve this tracking. This clocking mechanism is typically quite complicated and expensive to build.

Radio transmission technology also involves digital modulation schemes used to modulate digital signals for radio transmission. One step in some modulation schemes entails transforming or encoding raw digital data, comprising a series of bits in binary code, into a digital square wave signal that can be sent by a radio transmitter to a radio receiver. For example, as can be seen in FIG. 1a, one modulation scheme encodes raw data by transmitting a high voltage to represent a 1-bit and a low voltage for a 0-bit. The problem with this type of encoding is that when several identical bits are sent in succession, as with the 1-1 succession that commences the signal shown, the receiver cannot inherently differentiate between when one bit stops and the next bit starts. As a result, several improved encoding schemes have been developed to solve this problem.

One of these improved encoding schemes, Manchester encoding, transmits two voltages—one high and one low—for each bit. As shown in FIG. 1b, the “normal” type of Manchester encoding transmits a high and then low voltage for a 1-bit, and a low and then high voltage for a 0-bit. As shown in FIG. 1c, the “Differential” type of Manchester encoding indicates each bit by looking at the last half of the previous bit's signal. In particular, a Differential Manchester signal indicates a 1-bit by transmitting the first half of the signal at a voltage equal to the last half of the previous bit's signal. The first half of a 0-bit signal is transmitted at the voltage level opposite to the last half of the previous bit's signal. As with a normal Manchester signal, the Differential Manchester represents each bit by two voltages—i.e., there is a transition between signal levels in the middle of the portion of the signal that represents each bit. Thus, because each bit representation in a Manchester signal has a transition in the middle, the radio receiver is able to synchronize more easily with the radio transmitter. In other words, the middle transition points serve as inherent “markers” that allow the radio receiver to differentiate between when one bit ends and another bit starts.

In sum, although several types of frequency hopping spread spectrum systems exist, there is nevertheless a need for frequency hopping spread spectrum technology that simplifies the synchronization process, is inexpensive, reliable, and easy to integrate with existing systems.

### SUMMARY AND OBJECTS OF THE INVENTION

Some embodiments of the present invention provide a frequency-hopping spread spectrum radio communications system that includes a compact radio transceiver having a sensitivity of between −110 and −107 dBm. In a preferred embodiment, the transceiver broadcasts digital signals by encoding them using 180-degree phase-shifted differential encoding and by attaching a header identifying the frequency channel of the signal. A network ID is also included in the header to identify the network that the radio belongs to. The network ID allows the receiver to detect broadcasted signals within its own network, and the channel identifier enables the receiver to know which frequency to switch to in order to track the hopped signal. The receiver knows to hop to the next channel upon detecting noise on the line.

A preferred embodiment of the present invention is designed to operate in the 900 MHz ISM frequency band, a band that does not require F.C.C. approval or licensing before use. Other embodiments are designed to operate in the 2.4 GHz ISM band, another band that does not require F.C.C. licensing.

Accordingly, it is an object of some embodiments of the present invention to provide a spread spectrum frequency hopping digital communications system that simplifies the synchronization process, is inexpensive, reliable, and easy to integrate with existing systems.

Another object of some embodiments of the present invention is to provide a spread spectrum frequency hopping digital communications system with exceptional receiver sensitivity.

A further object of some embodiments of the present invention is to provide a spread spectrum frequency hopping digital communications system that uses 180-degree phase-shifted encoding in conjunction with providing exceptional receiver sensitivity.

Another object of some embodiments of the present invention is to provide a spread spectrum frequency hopping communications system that uses 180-degree phase-shifted encoding in conjunction with a clockless receiver that synchronizes by detecting noise as well as by using a header containing network and channel information.

Yet another object of some embodiments of the present invention is to provide a spread spectrum frequency hopping communications system that includes a compact transceiver that is easily integrable with existing hardware and software.

These and other objects and features of the present invention will become more fully apparent from the following description, drawings, and the appended claims. Other objects will likewise become apparent from the practice of the invention as set forth hereafter.

### BRIEF DESCRIPTION OF THE DRAWINGS

The foregoing and other objects and features of the present invention will become more fully apparent from the accompanying drawings when considered in conjunction with the following description and appended claims. Although the drawings depict only typical embodiments of the invention and are thus not to be deemed limiting of the invention's scope, the accompanying drawings help explain the invention in added detail.

FIGS. 1a through 1c illustrate several types of digital encoding schemes used in prior art systems;

FIG. 2 illustrates a preferred encoding scheme of the present invention;

FIG. 3 shows one embodiment of the transceiver of the present invention;

FIGS. 4a through 4c depict pin descriptions of several possible embodiments of the transceiver of the present invention; and

FIGS. 5a through 5d show several circuit diagrams for some embodiments of the transceiver of the present invention.

### DETAILED DESCRIPTION OF THE PREFERRED EMBODIMENTS

The figures listed above are expressly incorporated as part of this detailed description.

It is emphasized that the present invention, as illustrated in the figures and description herein, can be embodied or performed in a wide variety of ways. Thus, neither the drawings nor the following more detailed description of the various embodiments of the system and method of the present invention limit the scope of the invention. The drawings and detailed description are merely representative of the particular embodiments of the invention; the substantive scope of the present invention is limited only by the appended claims.

The various embodiments of the invention will be best understood by reference to the drawings, wherein like elements are designated by like alphanumeric characters throughout. Moreover, it should be noted that because some embodiments of the present invention are computer-implemented, particular embodiments may range from computer executable instructions as part of computer readable media to hardware used in any or all of the following depicted structures. Implementation may additionally be combinations of hardware and computer executable instructions. For brevity, computer readable media having computer executable instructions may sometimes be referred to as “software” or “computer software.”

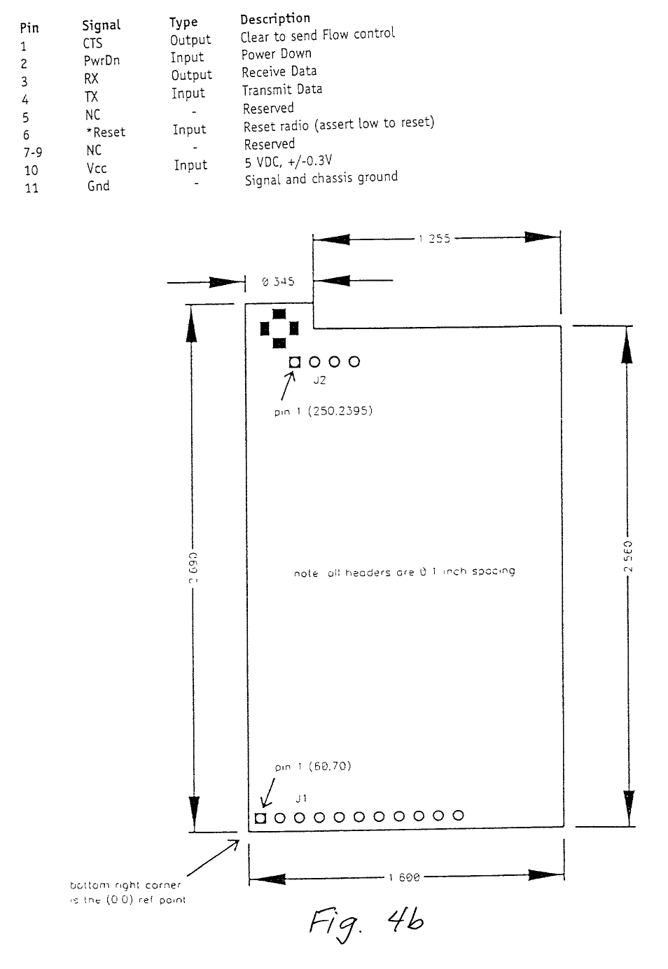

With reference now to the accompanying drawings, FIG. 3 shows one embodiment the present invention. Preferably, the present invention includes a radio or transceiver embodied in compact modem board that is smaller than a standard credit card. The transceiver includes a device for transmitting a data signal as well as a device for receiving a data signal. The transceiver can be easily integrated with existing hardware and software to enable wireless connectivity, custom RF engineering and wireless connectivity solutions. Preferably the receiver has exceptional sensitivity, ranging between −110 and −107 dBm.

In a preferred embodiment, the radio or transceiver of the present invention broadcasts digital signals by encoding them using 180-degree phase-shifted differential encoding (described below) and by attaching a header identifying the frequency channel of the signal. A network ID is also included in the header to identify the network that the radio belongs to. The network ID allows the receiver to detect broadcasted signals within its own network, and the channel identifier enables the receiver to know which frequency to switch to in order to track the hopped signal. The receiver knows to hop to the next channel upon detecting noise on the line. A more detailed description follows of how the present invention operates.

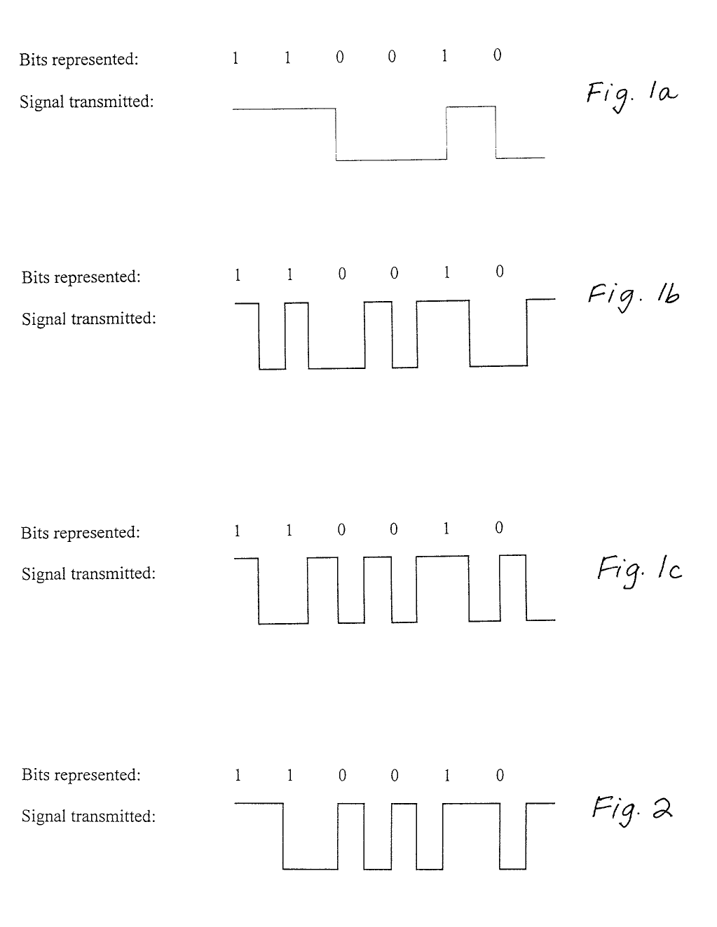

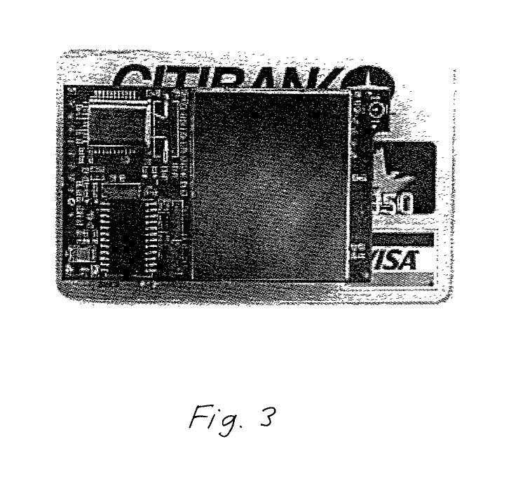

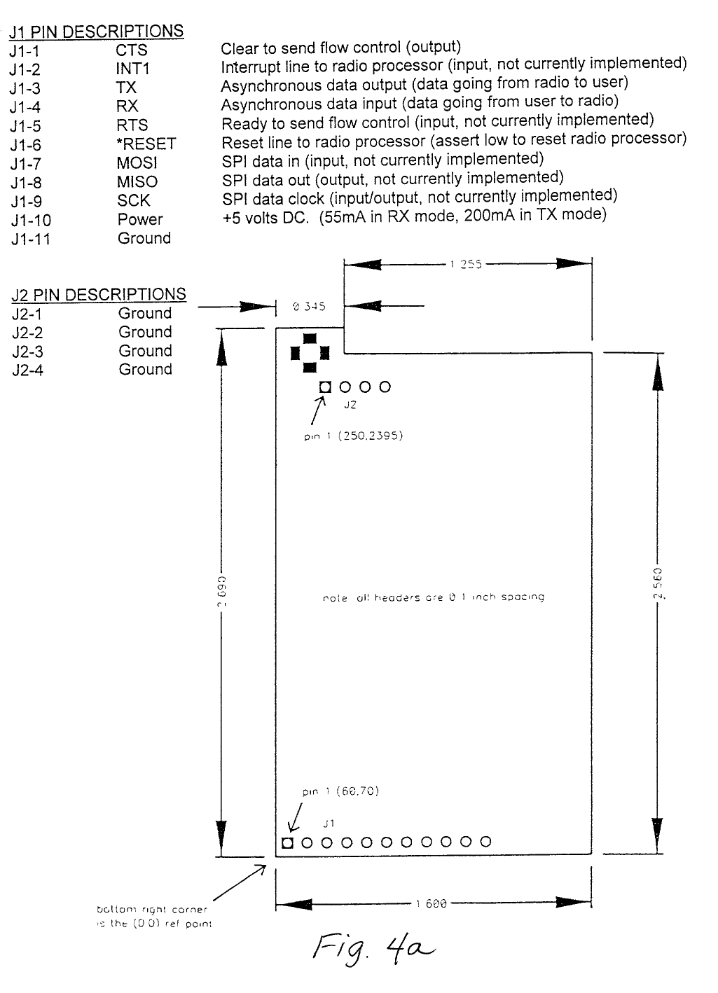

Referring now to FIG. 2, a preferred encoding scheme of the present invention is shown. As can be seen in FIG. 2, this encoding scheme has the synchronization advantages of the Manchester scheme (shown in FIGS. 1b and 1c) but is even easier to implement in software and to demodulate. In particular, this encoding scheme involves the transmission of two types of bit-representation signals: a “long” signal and a signal with a transition in the middle. Also, each bit-representation signal begins with a voltage level that is opposite to that of the previous bit's voltage level. The present application thus refers to the invention's encoding scheme as a “180-degree phase-shifted differential” encoding scheme. For example, FIG. 2 shows an embodiment of the present invention's encoding scheme where a 1-bit is indicated by a 2-period voltage, and a 0-bit is indicated by one voltage level for the first half of the 0-bit signal and the opposite voltage level for the second half of the 0-bit signal. As can be seen from the example above, the present invention's encoding scheme is particularly easy to synchronize and demodulate because the shift in voltage levels for each new bit signal, when combined with the presence of a “long” bit signal, makes it easy for the receiver to differentiate between bits.

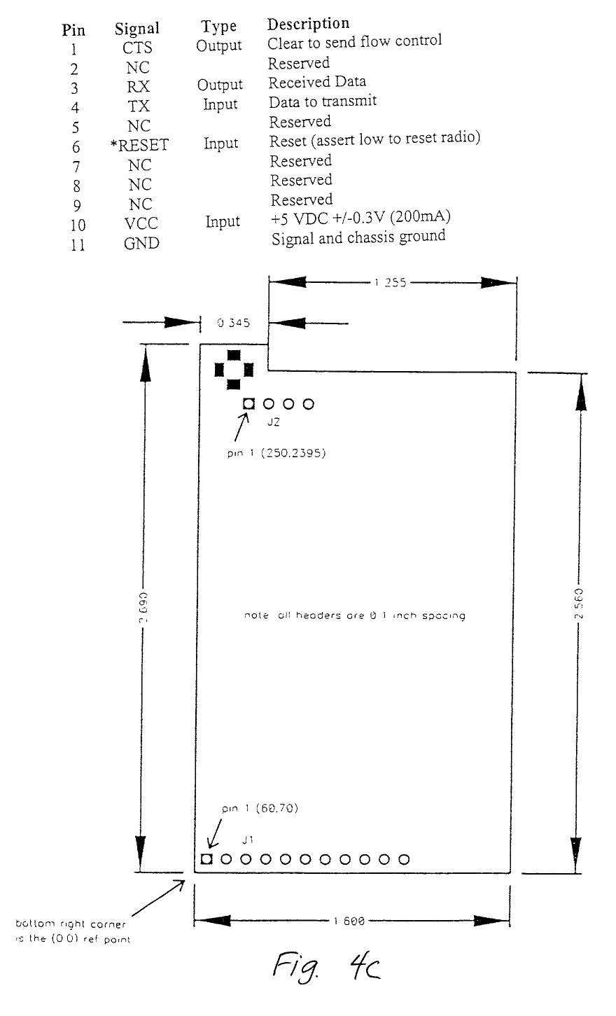

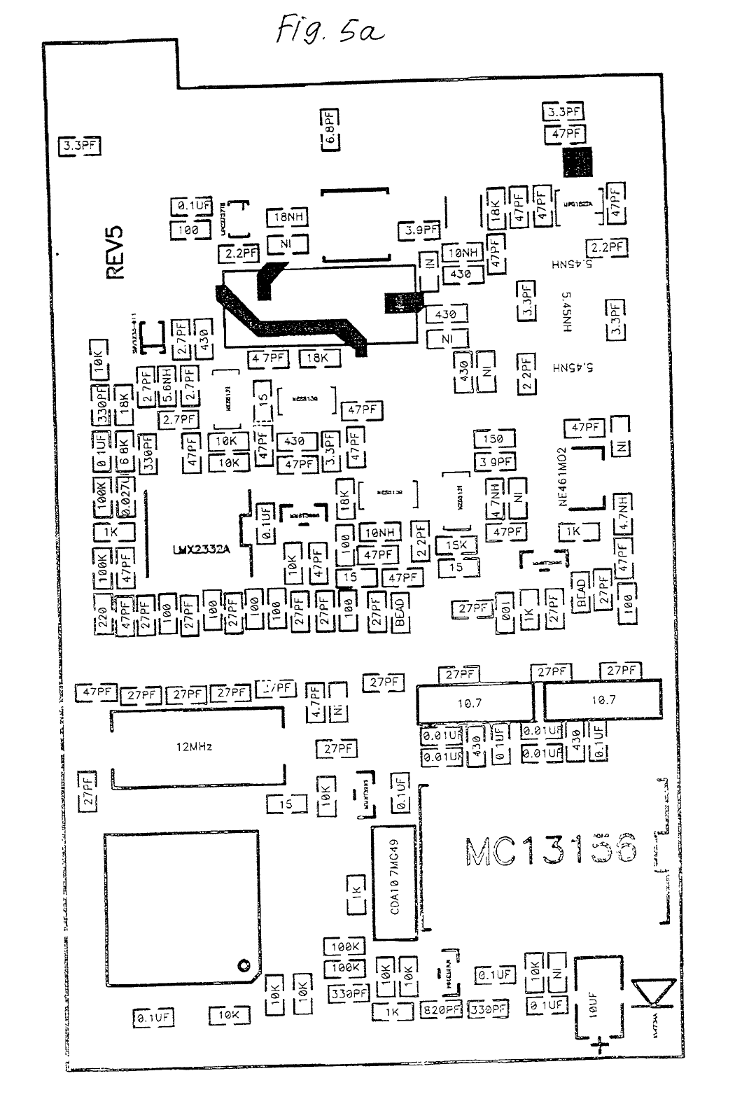

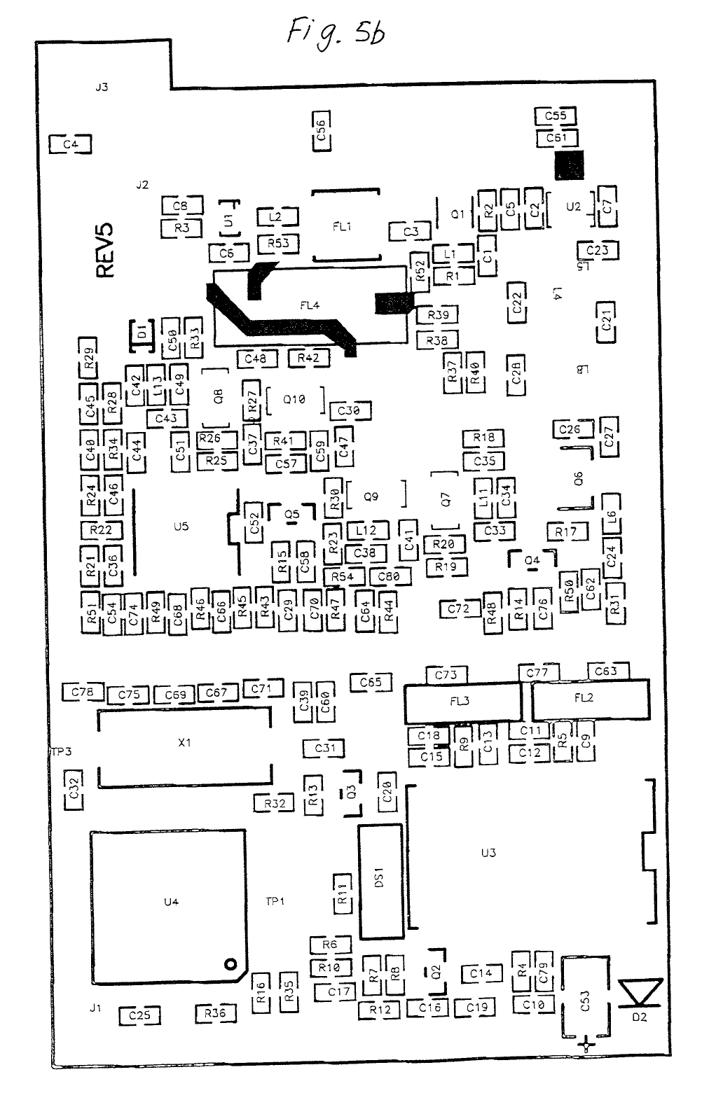

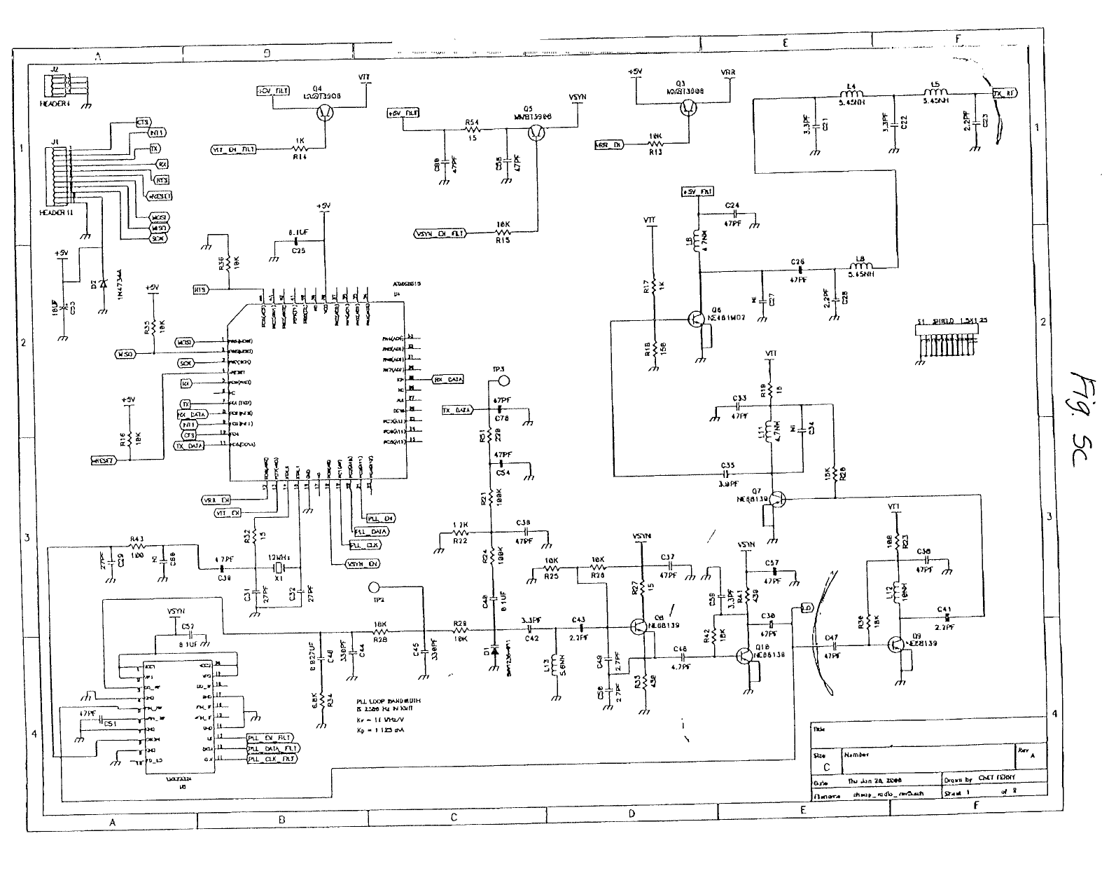

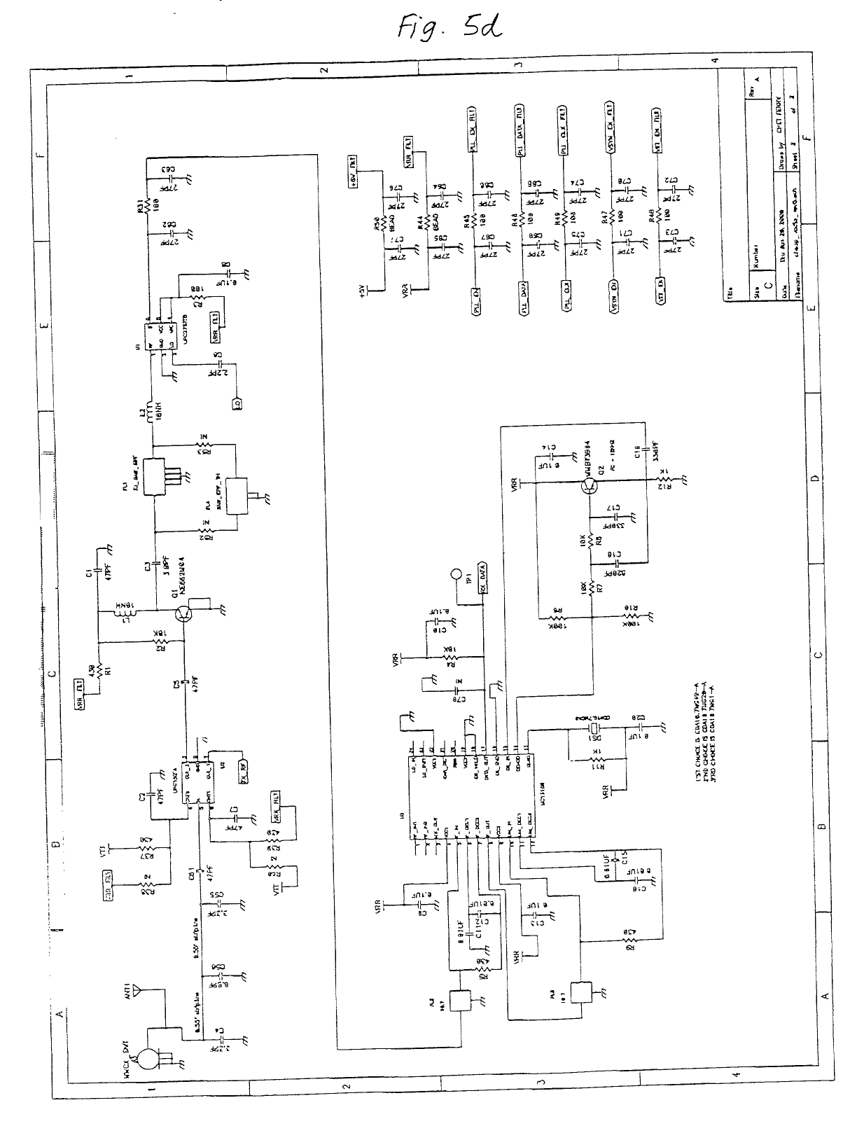

Referring now to FIGS. 4a through 4c, pin descriptions of several possible embodiments of the transceiver of the present invention are shown. FIGS. 5a through 5d show several circuit diagrams for some embodiments of the transceiver of the present invention. The information below gives the specifications of preferred embodiments of the present invention:

Sample specifications of preferred embodiments of the present invention

General

Transport Protocol—Transparent networking

Network Topology—Multi-drop (other embodiments include point-to-point)

Channel Capacity—Hops through 25 channels, Up to 65,000 Net IDs

Serial Data Interface—Asynchronous (RS-232) CMOS (TTL) signals, 5 V, 3.3 V tolerant I/O Data Rate—1200, 9600 or 19200 bps, set at factory (performance specifications vary with the data rate)

Performance

Channel Data Rate—10 k or 20 k bps respectively (varies with data rate)

Transmit Power Output—100 mW

Rx Sensitivity— −110, −109, or −107 respectively

Range—Indoor: 600′ to 1300′; Outdoor: 7 mi. with dipole, >20 mi. w/high gain antenna (calculations are for 9600-baud radio, line-of-sight; actual range will vary based upon specific board integration, antenna selection, environment and the device that the radio is integrated with)

Interference Rejection—70 dB at pager and cellular phone frequencies

Power Requirements

Supply Voltage—5 VDC +/−0.3 V

Current Consumption—Tx−170 mA nominal, Rx−50 mA or 80 mA nominal

Physical Properties

Board Size—1.6″×2.7″×0.35″

Weight—0.8 oz

Connector—11 pin 0.1″ spaced male berg type header

Operating Temperature— −40° C. to 85° C.

Operating Humidity—10% to 90% (non-condensing)

Antenna

Antenna Connector—MMCX Female

Antenna Impedance—50 Ohms unbalanced

Approved Antennas—Integral wire antenna (factory installed)

Astron AXQ9PRLMMCX—¼ wave flexible whip

Astron AXH900 RP SMAR—½ wave flexible whip, SMA

The below now describes in more detail the method of how the some embodiments of the present invention operate.

Operating states of some preferred embodiments

Standby

When the radio is neither transmitting nor receiving, it is preferably in Standby mode, ready to receive a broadcast signal. From Standby, the radio can either transmit, if data is presented on the serial port. The radio can also receive, if data is presented over the air. The radio will return to Standby when data is no longer present either on the air or on the serial port, or if a receive error is detected.

Transmitting

When data is presented to the serial port, the preferred embodiment of the radio must first leave Standby mode; it will then send the incoming data over the air. Transitioning from Standby mode to Transmit mode takes approximately 50 milliseconds (ms). This delay is seen as the latency between the time the transmitter receives data in the serial port, and the time the receiver transmits data out the serial port. While leaving Standby, the radio can buffer up to 48 characters before it must stop receiving characters. The radio will preferably assert the CTS flow control line when approximately 32 characters have been received to notify the sending device to stop sending data.

Once in Transmit mode, the radio will preferably start to send the buffered data. Data is sent in packets up to 32 bytes long. As soon as the radio starts sending a packet, the CTS line is de-asserted and more data can be sent to the radio. After the initial delay, there should be very little if any assertion of CTS and data can be continuously sent to the radio. In a preferred embodiment, the radio operates in half-duplex mode only and cannot receive while transmitting.

Receiving

If data is present on the airwaves when the radio is in Standby, it will transition to Receive mode. In Receive mode it will receive a packet and transmit it out the serial port. Received packets are preferably analyzed for data corruption using proprietary technology. These protections include a 16-bit network identifier (NetID) allowing multiple networks or radios to operate in the same vicinity by using different NetIDs. A packet is rejected and not sent out the serial port if the network identifier is incorrect or if an error is detected in the packet.

In some embodiments, the radio of the present invention will stay in Receive mode until no more data is detected or an error is detected. A receiving radio will not transmit data coming IN to the serial port until after returning to Standby mode.

The radios of the present invention include built in support for multi-drop networking. All radios within range of a transmitter and with the same network address receive all valid transmissions. Because of the transparent network protocol, no notification is given when packets are dropped and there are no retries or guaranteed delivery of packets. In the preferred embodiments, no attempt is made to verify whether the packet was received (i.e., there is no acknowledgment process). Preferably, addressing, checksums (CRCs) and retries can be handled outside of the radio as in a multi-drop, parallel-wired network (RS-485 type).

When there are gaps in receiving data, the receiver preferably automatically returns to Standby mode. If the receiver has buffered data coming in to the serial port, this data will be sent after the radio returns to Standby mode.

The system of the present invention comprises a spread spectrum frequency hopping system that preferably operates within the 900 MHz ISM frequency band, a band that conveniently does not require F.C.C. approval or licensing before use. Other embodiments are designed to operate in the 2.4 GHz ISM band, another band that does not require F.C.C. licensing.

The present invention may be embodied in other specific forms without departing from its spirit or essential characteristics. The described embodiments herein should be deemed only as illustrative. Indeed, the appended claims indicate the scope of the invention; the description, being used for illustrative purposes, does not limit the scope of the invention. All variations that come within the meaning and range of equivalency of the claims are to be embraced within their scope.

What is claimed is:

1. A method for digital data transmission comprising:
modulating a digital signal into a modulated signal for radio transmission, said modulating comprising encoding raw digital data using 180-degree phase-shifted encoding;
broadcasting said modulated signal with a network identifier, said broadcasting comprising spread spectrum frequency hopping transmission;
detecting said broadcasting with a device having a sensitivity of between −110 and −107 dBm;
tracking said modulated signal by differentiating between the signal and noise; and
decoding said modulated signal.

2. A system for transmitting data comprising:
means for encoding a digital signal into a 180-degree phase-shifted encoded signal;
means for transmitting said encoded signal as a spread spectrum frequency hopped signal; and
means for receiving said spread spectrum frequency-hopped signal.
